(19) United States
(12) Patent Application Publication
(10) Pub. No.: US 2026/0093765 A1
(43) Pub. Date: Apr. 2, 2026

(54) SYSTEMS AND METHODS OF CONTROLLING REDIRECTION OF CLIENTS VIA ENCODED LINKS

(71) Applicant: Bitly, Inc., New York, NY (US)

(72) Inventors: Michael Richman, Denver, CO (US); Jehiah Czebotar, New York, NY (US)

(21) Appl. No.: 19/343,577

(22) Filed: Sep. 29, 2025

Related U.S. Application Data
(60) Provisional application No. 63/701,252, filed on Sep. 30, 2024.

(51) Int. Cl. G06F 16/955; G06F 16/957

(52) U.S. Cl. CPC G06F 16/9558; G06F 16/9577

(57) ABSTRACT

Presented herein are systems and methods of redirecting clients through interaction with encoded links. A server of a linking system may receive, from a client, a request to access a target webpage via redirection through the linking system, in response to interaction with an encoded link of the linking system on a source webpage. The server may identify the target webpage to be accessed via the redirection based on the encoded link associated with the request. The server may determine a first metric indicating a degree of risk from presentation of the target webpage based on content on the target webpage. The server may determine a second metric indicating a frequency of visits to the target webpage via redirection through the linking system. The server may select a preview interstitial element, responsive to the first metric being below a first threshold and the second metric exceeding a second threshold.

### CROSS REFERENCE TO RELATED APPLICATIONS

The present application claims the benefit of priority under 35 U.S. C. § 119(e) to U.S. Provisional Patent Application No. 63/701,252 , titled 1.2537 Systems and Methods of Controlling Redirection of Clients via Encoded Links, filed Sep. 30, 2024, which is incorporated by reference in its entirety.

### BACKGROUND

In a networked computer environment, a server may host a webpage referenced by a web address. A client may use the web address to send a request over the network to access the webpage hosted by the server.

### SUMMARY

A client device may display a source webpage. The source webpage may include one or more encoded links (e.g., a Uniform Resource Locator (URL)). The encoded links may have been generated by a linking system and may include an address to direct the client device through the linking system to a target webpage. As the client is redirected through the linking system in response to interaction with the encoded link prior to receipt of the target webpage, the linking system may have visibility and control of the redirection. For example, the linking system may present clients with preview interstitial elements prior to the target webpage.

However, there may be tradeoffs between the presentation of preview interstitial elements and immediate redirection to the target webpage. If the client is presented with the preview interstitial element, the likelihood of a user interacting with the preview interstitial element may decrease, resulting in the waste of computing resources (e.g., processor and memory) and network bandwidth in providing the element. On the other hand, if the client is redirected to the target webpage without the preview interstitial element, the user may lack awareness of the target webpage prior to the redirection and may not take any interaction with the target webpage. This also leads to the wasted consumption of computing resources (e.g., processor and memory) and network bandwidth in providing the target webpage.

To address these and other technical issues, the linking system may algorithmically logic control the frequency of preview page displays based on target webpage content, encoded links, and user session data, among other factors. The selective provision can dynamically adjust the percentage of visits that trigger preview interstitial elements. Upon receiving a request from a client to be redirected to a target webpage, the linking system may evaluate the content category and risk score of the target URL. If the category is deemed inappropriate for preview display (e.g., sensitive or non-safe content), the client may be presented with a preview interstitial element for that target URL if subsequent decision tiers deem such display is warranted. The preview interstitial may include, for example, a notice indicating that the content of the target webpage is potentially unsafe and include various information about the target webpage (e.g., full URL address).

In addition, the linking system may examine HTTP request headers to ensure that the request is appropriate for returning HTML content. If the request indicates a non-HTML response is expected (e.g., image, video), the user may be directly redirected to the target webpage. The linking system may check the type of account that created the encoded link. For instance, encoded links of free accounts might be subject to preview interstitials more frequently than paid accounts. The linking system may track number of times a specific encoded link has been interacted with. After reaching a threshold, the system may begin displaying a preview interstitial element for a percentage of subsequent visits to the same URL. Conversely, encoded links with interactions below the threshold may be subject to fewer preview interstitials.

The linking system may track a frequency of provision of preview interstitial element for the given encoded link across clients. This may prevent a single client from repeatedly being presented with preview interstitial elements. Tracking encoded link interactions with preview interstitials may utilize browser cookies maintained using the encoded links via the linking system. The frequency of client interactions with preview interstitials may be compared to a threshold. When the frequency is above the threshold, the linking system may redirect the client directly to the target webpage. When the frequency is below the threshold, the linking system may present the client with a preview interstitial element.

In some cases, even if it is deemed desirable to display to the client a preview interstitial element, some content categories may not be appropriate for displaying ad content. The linking system may perform the assessment based on the content category of the target webpage to determine whether to display ad content alongside other preview content of a preview interstitial element. For instance, if the content falls into an abuse category, it may not be appropriate to display a preview interstitial element including ad content. A preview interstitial element may still be displayed for a target webpage, but in these cases, the preview interstitial element may not be accompanied by additional content. The determination as to whether to provide the preview interstitial element or redirect the client to the target webpage may be performed within a short time period (e.g., within 10-100 milliseconds) from the receipt of the request. The linking system may facilitate this performance by caching previous determinations with different factors (e.g., risk level, content category, frequency, and metadata). When a new request is received, the linking system may perform a quick lookup of previous determinations within the time period to determine whether to provide the preview interstitial element or redirect the client in connection with the new request.

By determining whether to display a preview interstitial, or redirect the client to the target webpage, the linking system can efficiently allocate the usage of computing resources (e.g., processor and memory on the part of the client, the linking system, and the host server) and network bandwidth. By leveraging previous determinations, the linking system may reduce latency and minimize redundant computations especially for frequently accessed encoded links. In addition, using the risk metrics, the linking system can protect client devices from interacting with harmful content, such as malware, phishing, spam, spyware, and other sensitive content.

The algorithmic logic of the linking system may also avoid overwhelming users with the number of preview interstitial elements, thereby improving the quality of human-computer interaction (HCI) between the user and the client.

Aspects of the present disclosure are directed to systems and methods of redirecting clients through interaction with encoded links. At least one server of a linking system may receive, from a client, a request to access a target webpage via redirection through the linking system, in response to interaction with an encoded link of the linking system on a source webpage. The server may identify the target webpage to be accessed via the redirection based on the encoded link associated with the request. The server may determine a first metric indicating a degree of risk from the presentation of the target webpage based on content on the target webpage. The server may determine a second metric indicating a frequency of visits to the target webpage via redirection through the linking system. The server may select an interstitial element that previews at least a portion of the target webpage, responsive to the first metric being below a first threshold and the second metric exceeding a second threshold. The server may transmit, to the client, a response to cause the client to present the interstitial element on the source webpage, instead of redirecting the client to the target webpage.

In some embodiments, the server of the linking system may receive, from the client, a second request to access a second target webpage via redirection through the linking system, in response to interaction with a second encoded link of the linking system on a second source webpage. In some embodiments, the server of the linking system may determine a third metric indicating a frequency of visits by the second target webpage. In some embodiments, the server may select the second target webpage instead of a second interstitial element corresponding to at least a portion of the second target webpage, responsive to the third metric being below the second threshold. In some embodiments, the server of the linking system may transmit, to the client, a second response to redirect the client from the second source webpage to the second target webpage, instead of the presentation of the second interstitial element on the second source webpage.

In some embodiments, the server of the linking system may determine a third metric indicating a degree of risk from presentation of a second target webpage based on content on a second target webpage. In some embodiments, the server of the linking system may generate a second interstitial element to include at least one of the target webpage URL, a page title, a page description, or a keyword associated with a second target webpage, responsive to the third metric exceeding the first threshold. In some embodiments, the server of the linking system may generate the interstitial element to include at least the portion of the target webpage, responsive to the first metric being below the first threshold.

In some embodiments, the server of the linking system may determine that the request is valid based on a type of content identified in a header of the request. In some embodiments, the server of the linking system may select the target webpage instead of the interstitial element, responsive to determining that the request is valid. In some embodiments, the server of the linking system may identify a type of account for a content provider associated with the encoded link as corresponding to a defined type. In some embodiments, the server of the linking system may select the target webpage instead of the interstitial element, responsive to identifying the type of account as corresponding to the defined type.

In some embodiments, the server of the linking system may identify an activity log of the client in accessing target webpages via the redirection through the linking system using a cookie of the linking system on the client, responsive to the first metric exceeding the first threshold. In some embodiments, the server of the linking system may determine a third metric indicating a number of visits by the client to the target webpage based on the activity log. In some embodiments, the server of the linking system may select the target webpage instead of the interstitial element, responsive to the third metric exceeding a third threshold.

In some embodiments, the server of the linking system may identify an activity log of the client in accessing target webpages via the redirection through the linking system using a cookie of the linking system on the client, responsive to the first metric exceeding the first threshold. In some embodiments, the server of the linking system may determine that the client was presented with a second interstitial element in response to a second request to access a second target webpage via the redirection through the linking system. In some embodiments, the server of the linking system may select the target webpage instead of the interstitial element, responsive to determining that the client was presented with the second interstitial element.

In some embodiments, the server of the linking system may select a subset of tiers from a plurality of tiers against which to check the request, the subset of tiers including (i) comparing the first metric indicating the risk against the first threshold and (ii) comparing the second metric indicating frequency of visits against the second threshold. In some embodiments, the server may generate, using a resource identifier referencing a host server and the first target webpage, the encoded link configured to redirect the client through the linking system to the first target webpage referenced by the resource identifier. In some embodiments, the server of the linking system may store, on a database, (i) a determination to select the preview interstitial element and (ii) a plurality of factors including the first metric and the second metric.

### BRIEF DESCRIPTION OF THE DRAWINGS

The foregoing and other objects, aspects, features, and advantages of the present invention will become more apparent and better understood by referring to the following description taken in conjunction with the accompanying drawings, in which:

FIG. 1 is a diagram of an embodiment of a system to shorten, share, and track links in accordance with an illustrative embodiment.

FIG. 2 depicts a block diagram of a system for redirecting clients through interaction with encoded links in accordance with an illustrative embodiment.

FIG. 3 depicts a block diagram of a process to handle requests to be redirected to target webpages in response to interactions with an encoded link in the system for redirecting clients through interaction with encoded links in accordance with an illustrative embodiment.

FIG. 4 depicts a block diagram of a process to provide preview interstitial elements in the system for redirecting clients through interaction with encoded links in accordance with an illustrative embodiment.

FIG. 5 depicts a block diagram of a process to provide target web pages in the system for redirecting clients through interaction with encoded links in accordance with an illustrative embodiment.

FIG. 6A-C depicts flow diagrams of a method of redirecting clients through interaction with encoded links in accordance with an illustrative embodiment.

FIG. 7 depicts a system for decoding request and webpage data to make a targeted content determination regarding the redirection from a source webpage to a target webpage.

FIG. 8 depicts a preview interstitial element that incorporates a content item, in accordance with an illustrative embodiment.

FIG. 9 depicts a block diagram of a representative server system, client computing system, and network usable to implement certain embodiments of the present disclosure.

### DETAILED DESCRIPTION

Following below are more detailed descriptions of various concepts related to, and embodiments of, systems and methods for redirecting clients through interaction with encoded links. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

Section A describes systems and methods for shortening, sharing, and tracking links, according to embodiments described herein.

Section B describes systems and methods for redirecting clients through interaction with encoded links, according to embodiments described herein.

Section C describes a network environment and computing environment, which may be useful for practicing various computing-related embodiments described herein.

### A. Systems and Methods for Shortening, Sharing, and Tracking Links

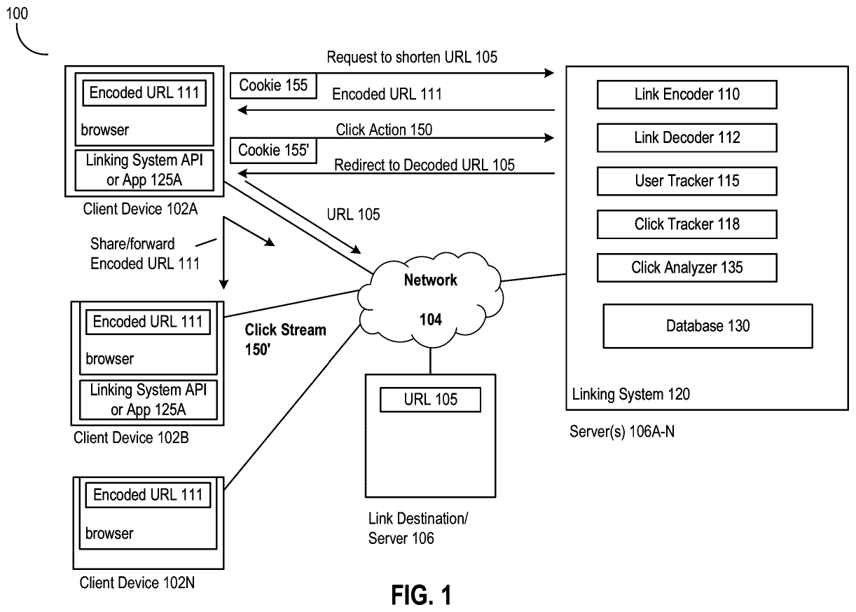

Referring now to FIG. 1, embodiments of a system 100 for shortening, sharing, and tracking links are depicted. In brief overview, a linking system 120 executes on one or more server(s) 106A-N and may be accessed by a plurality of clients 102A-N via a network 104. The linking system 120 may include a link encoder 110 that shortens a link, such as a uniform resource locator (URL) 105 to a resource on a destination server 106. The link encoder 110 may encode (e.g., shorten) the link responsive to a request to shorten the URL 105. The client may include a link system API or application 125A-N to interface with the linking system 120 and request to shorten the link. The request may include a cookie 155 identifying user and client information. The link encoder 110 may generate or otherwise provide an encoded URL 111 to a client. The link encoder 110 may store in a database 130 information about the encoding of the URL and the URL 105. The user tracker 115 may track information about the user, such as via the cookie 155 and store the information in the database 130.

Via the browser of the client, a user may click on or otherwise activate 150 the encoded URL 111 which directs the browser to the linking system 120. The click action 150 may be a request to decode the URL. The click action or request thereof may include a cookie 155′ which provides user and client information. The link decoder 112 may decode the encoded URL 111, such as via database 130. For example, the link decoder 112 may perform a lookup of the URL corresponding to the shortened or encoded URL. The linking system, such as via decoder 112, may send a redirect, such as a Hypertext Transfer Protocol (HTTP) redirect (e.g., 301 redirect), to the client to the decoded URL 105. The browser of the client may access or be directed to the URL 105 of the link destination server 106. The click tracker 118 may track user actions on the encoded URL, such as when the encoded URL was clicked, from what source and by what user, and store such tracking in the database 130. The click tracker 118 and/or user tracker 115 may track user information from the cookies 155′ in connection with or associated with the click action 150. The click tracker 118 and/or user tracker 115 may track and store the user's referrer information from the request.

A user of client 102a may share via email, website posting, social networking, etc. The encoded URL 111 to any one or more other users, such as users of clients 102b-102N. Any of these users may click on or activate the encoded URL 111. The plurality of click actions on the encoded URL provides a stream of requests from user click actions to decode the encoded URL, which may be generally referred to as a click stream 150′. The linking system via link decoder 112 may decode the encoded URL and redirect each of the clients to the URL 105. The user tracker 115 and click tracker 118 may track information on the user and the click actions of the click stream 150′ in the database. The click analyzer 135 may provide metrics on the click actions of the encoded URL, such as the number of clicks, the times of clicks, and the sources of the clicks.

In further details, the linking system 120 may comprise an application, program, library, process, service, script, task, or any type and form of executable instructions executable or executing on a device. The linking system may operate on a plurality of servers 106A-106N. The linking system may comprise logic, function, and operations for shortening, sharing, and tracking links, such as URLs. The linking system may comprise application programming interfaces, such as web services, XML, Jason (JSON), etc., for accessing the functionality, operations, and/or data of the linking system. The linking system may include one or more modules, components or executables for providing these APIs and performing the functions and operations described herein. For example, in some embodiments, the linking system may include a link encoder 110, a link decoder 112, a user tracker 115, a click tracker 118, and a click analyzer 135. The modules, components, or executables of the linking system may operate in a client/server architecture. The modules, components or executables of the linking system may operate in a distributed manner across multiple devices.

The linking system may include, operate, communicate, or interface with a linking system API or application 125A-N (generally referred to as 125). In some embodiments, an application 125 may execute on the client that communicates with or interfaces to the linking system to encode and decode URLs. In some embodiments, an application 125 may include any portion of the linking system. In some embodiments, the application may be a mobile application, generally referred to as an app, executing on a mobile device, such as a smartphone or tablet device. In some embodiments, the application may include an add-on, extension, script, ActiveX control, applet, widget, or other types and forms of executable instructions executed by or in a browser. In some embodiments, the application may include, use or call one or more APIs to the linking system. The application may be programmed to programmatically integrate the linking system, or interface thereto, into the application. Via the one or more APIs, the application may access data from the linking system. Via the one or more APIs, the application may perform or execute any of the functions or operations of the linking system. Via the one or more APIs, the application may perform or execute any of the systems and methods described herein.

The link encoder 110 may include an application, program, library, process, service, script, task, or any type and form of executable instructions for encoding a link. The link encoder 110 may shorten a URL. The encoded URL may be referred to as, or be, a shortened URL. Creating a shortened link may be referred to as encoding. The link encoder 110 may shorten the URL to a predetermined string length or to a predetermined number of characters. The link encoder 110 may shorten the URL to a length determined responsive to the length of the URL to be encoded. The link encoder 110 may encode the URL into an encoded URL using an encoding scheme. In some embodiments, the link encoder 110 applies a hash to the URL to generate or produce the encoded URL. In some embodiments, the encoded URL is a hash or hash code. In some embodiments, the link encoder 110 transforms the URL using a transformation function, such as a reversible transformation function. In some embodiments, the link encoder 110 removes a portion of the URL. In some embodiments, the link encoder 110 rewrites a portion of the URL with a portion of another URL. In some embodiments, the link encoder 110 encrypts the URL or a portion of the URL using one or more encryption keys. In some embodiments, the link encoder 110 generates a unique identifier for the encoded URL in which the unique identifier uniquely identifies the URL. In some embodiments, the link encoder 110 obfuscates information from the original URL, such as information relating to a directory structure of the server from the URL. The link encoder 110 may encode the URL into an encoded URL that comprises a domain name hosted by or recognized by the linking system or any server thereof. The link encoder 110 may encode the URL into an encoded URL that comprises a domain name configured, specified, or identified by a user, such as a domain name of an entity that is a user of the linking system. The link encoder 110 may encode the URL to identify a URL of the linking system, such as a landing page or intermediate page of the linking system. In some embodiments, the link encoder 110 may encode the URL to be resolved to an intermediate URL or page of the linking system prior to being redirected by the linking system to the URL after decoding.

The link decoder 112 may include an application, program, library, process, service, script, task, or any type and form of executable instructions for decoding an encoded link. The link decoder 112 may be designed and constructed to decode, un-shorten, generate, produce, or otherwise provide the original URL corresponding to the encoded URL. Clicking on a shortened link may be referred to or called decoding. In some embodiments, the link decoder 112 determines the URL from the encoded URL via lookup in the database. In some embodiments, the link decoder 112 uses the encoded URL as an index to look up the URL in the database. In some embodiments, the link decoder 112 uses the encoded URL as a hash index into a hash table of the database. In some embodiments, the link decoder 112 uses the encoded URL or a portion thereof as a unique identifier to the URL stored in memory, storage of database of the linking system. In some embodiments, the link decoder 112 uses a decoding scheme designed and constructed to perform the reverse of the encoding scheme or otherwise produce or generate the original input (e.g., the URL) to the encoding scheme. In some embodiments, the link decoder 112 applies a reverse transformation function to the encoded URL. In some embodiments, the link decoder 112 replaces a portion of the encoded URL with a portion of the URL. In some embodiments, the link decoder 112 un-obfuscates information in the encoded URL to a portion of the original URL. In some embodiments, the link decoder 112 replaces a domain name of the encoded URL with a domain name of the URL.

In some embodiments, the linking system, such as via link decoder 112, generates, issues, or communicates a redirect responsive to receipt of an encoded URL and/or decoding the encoded URL. In some embodiments, the linking system issues any type of 3XX HTTP redirect. In HTTP, a redirect is a response with a status code beginning with a 3XX that induces a browser to go to another location. In some embodiments, the response or status code includes an annotation describing the reason, which allows for the correct subsequent action (such as changing links in the case of code 301, a permanent change of address). In some embodiments, the linking system issues a 301 type of HTTP redirect. In some embodiments, the redirect response comprises or uses a technique for making a webpage available under many URLs. In some embodiments, the linking system uses scripting for redirection. In some embodiments, the linking system uses a refresh meta tag or HTTP refresh header technique for redirection.

In some embodiments, when the user clicks on or activates the shortened link (e.g., encoded URL 111) the user or browser is taken to an interstitial page of the linking system, and then using an HTTP redirect page, an intermediate website of the linking system refers the user to the final destination site of URL 105. While doing so, the intermediate website may track from which website the user clicked on the short link, store various user-specific data, and note any related cookies, or if there are no cookies, store a new cookie on the user for the future.

A user of one device, such as client device 102, may share the encoded URL 111 with a plurality of users, such as users on client devices 102b-102N. A user or application may share the encoded URL by emailing the encoded URL to a user. A user or application may share the encoded URL by posting or publishing the encoded URL to a website. A user or application may share the encoded URL by posting, publishing, or forwarding the encoded URL to a social networking site, such as but not limited to LinkedIn or Facebook. A user or application may share the encoded URL by texting the encoded URL. A user or application may share the encoded URL by posting or communicating the encoded URL via a communication tool, such as Skype or Instant Messenger. A user or application may share the encoded URL by serving the encoded URL in content served by a website. A user or application may share the encoded URL by serving the encoded URL in an advertisement or impression opportunity served by an ad server. A user or application may share the encoded URL via the linking system API or app 125, such as via a linking system bookmark applet on a browser. Any user receiving the encoded URL from any device may click on or activate the encoded URL to communicate with the linking system and be directed to the URL decoded from or corresponding to the encoded URL.

A click tracker 118 may include an application, program, library, process, service, script, task, or any type and form of executable instructions for tracking actions regarding an encoded URL and/or decoding the encoded URL. In some embodiments, the click tracker 118 identifies each instance of a user clicking on an encoded URL and tracks the number of clicks for the URL via the encoded URL in the database 130. In some embodiments, the click tracker 118 identifies each instance of a user clicking on any of a plurality of encoded URLs that correspond to a URL and tracks the number of clicks for the URL via any encoded URL in the database 130. In some embodiments, the click tracker 118 may identify and track via the database any temporal information regarding the clicks on the encoded URL, such as date and time of the click action 150. In some embodiments, the click tracker 118 may identify and track via the database any source information regarding the clicks on the encoded URL, such a source internet protocol (IP) address, source port, and Machine Access Control (MAC) identifier of the device from which the user clicked on the encoded URL. In some embodiments, the click tracker 118 may identify and track via the database any header, field, or other information via any application layer payload, such as the HTTP payload of the packet(s) carrying the click action or request to decode the URL. In some embodiments, the click tracker 118 may identify and track via the database the HTTP header field of referrer to identify and track the URL or webpage from which the click action or request was referred or originated.

A user tracker 115 may include an application, program, library, process, service, script, task, or any type and form of executable instructions for tracking and managing information regarding users of the linking system and/or users interacting with encoded and decoded URLs. The user tracker 115 may include an interface, such as a web page, to have users register as users of the linking system. The user tracker 115 may collect via registration authentication information of the user, such as a user identifier and a password. The user tracker 115 may identify and collect information from any type and form of cookie 155. The user tracker 115 may receive the cookie via a request to shorten a URL. The cookie may be any third-party cookie. The cookie may be a cookie generated by, provided by, or tracked for the linking system. The user tracker 115 or linking system may insert, modify, or provide any data, information, or attributes in the cookie for the linking system. The user tracker 115 or linking system may include or provide a cookie 155′ in communicating the redirect response for a click action that decodes the encoded URL. The cookie may comprise information, data, or attributes that identify the user, any user's actions, preferences of the user, and/or history of user activity or behavior. The cookie may comprise information, data, or attributes that identify any click actions. The cookie may comprise information, data, or attributes that identify the URL and/or any encoding and/or decoding of the URL. The cookie may comprise information, data, or attributes of redirection or the redirect response by the linking system. The user tracker 115 may identify and track any user activity in encoding URLs. The user tracker 115 may identify and track any user activity in decoding URLs. The user tracker 115 may identify and track any user activity in sharing encoded URLs. The user tracker 115 may store tracked information, data, and attributes in the database.

In some embodiments, the click tracker 118 comprises the user tracker 115 or a portion thereof. In some embodiments, the user tracker 115 comprises the click tracker 118 or a portion thereof. In some embodiments, a tracker 115 or 118 comprises both the click tracker 118 and user tracker 115. In some embodiments, the user tracker 115 is integrated with, interfaced to, or communicates with the click tracker 118. The user tracker 115 and click tracker 118 may be designed and constructed to track and store in the database information about encoding URLs, decoding URLs, and clicks of encoded URLs in association with users connected to the encoding of the URLs, decoding of the URLs, and clicking on the encoded URLs.

The database 130 may include an application, program, library, process, service, script, task, or any type and form of executable instructions for tracking and managing information and data stored by, accessed by, and/or used by the linking system or any modules or components thereof. The database may be any type and form of Structured Query Language (SQL) database. The database may be any type and form of object-oriented or object-based database. The database may be any type and form of in-memory or real-time memory database. The database may comprise any type and form of graphical database. The database may comprise any type and form of data warehousing and/or analytical database. The database may comprise any type and form of multi-dimensional database. The database may store any data and information from any of the functions, operations, systems, and methods described herein.

A click analyzer 135 may include an application, program, library, process, service, script, task, or any type and form of executable instructions for analyzing, searching, and/or reporting any of the information, data, and metrics stored by the linking system in the database 130. The click analyzer 135 may include any type and form of online analytical processing (OLAP). The click analyzer 135 may analyze click and user data stored in the database to determine a number of clicks to a URL per encoding of the URL. The click analyzer 135 may analyze click and user data stored in the database to determine a number of clicks to a URL for all encodings of the URL across a plurality of users. The click analyzer 135 may analyze click and user data stored in the database to determine a location of users who clicked on an encoded URL, such as what countries the clicks originated from. The click analyzer 135 may analyze click and user data stored in the database to determine the different referring sites from which users clicked on an encoded URL. The click analyzer 135 may analyze click and user data stored in the database to determine the different types of clients or client applications from which users clicked on an encoded URL. The click analyzer 135 may analyze click and user data stored in the database to determine a number of clicks over a predetermined time period or a frequency of clicks. The click analyzer 135 may analyze click and user data stored in the database to determine a number of conversations across different social media networks regarding or in connection with an encoded URL. The click analyzer 135 may provide any data, information, and/or analysis in a graphical format, such as any type and form of statistical charts or diagrams.

A plurality of users may click on 150 the same encoded URL 111. Each of these users may also click on a plurality of different encoded URLs to the same URL or to different URLs. The plurality of click actions 150 may generate and/or provide data that is tracked and stored via the linking system. The set of data resulting from a click action and/or data associated with the click and/or collected, tracked, and analyzed either statically or in real-time by the linking system may be referred to as a clickstream or click stream 150′. The click stream may include any data tracked by the user tracker 115. The click stream may include any data tracked by the click tracker 118, such as any network traffic data. The click stream may include any data provided by the browser. The click stream may include any data provided via the HTTP request. The click stream may include any data analyzed by the click analyzer 135. The click stream may include any data traversing the linking system.

### B. Systems and Methods for Redirecting Clients Through Interaction With Encoded Links

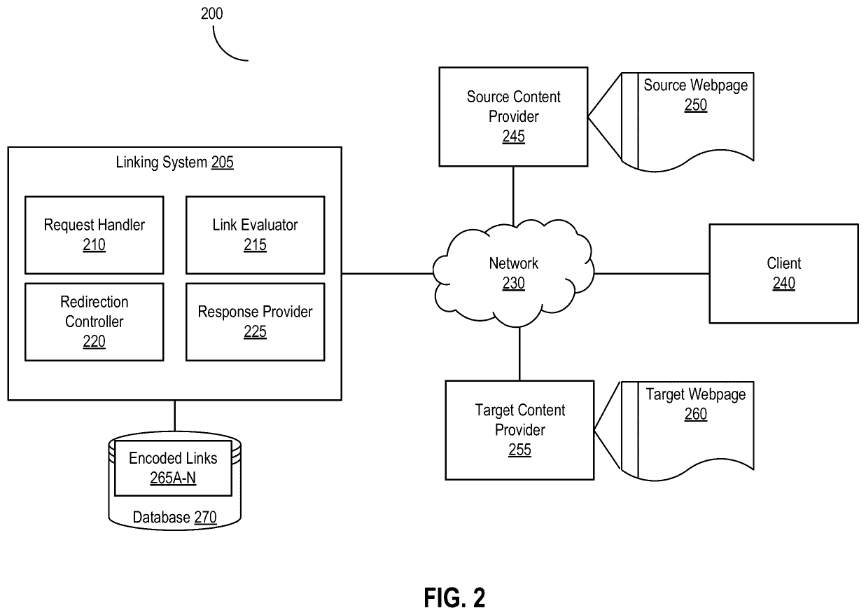

Referring now to FIG. 2 depicted is a block diagram of a system 200 for redirecting clients through interaction with encoded links. The system 200 may include at least one linking system 205, at least one client 240, at least one source content provider 245, at least one target content provider 255, and at least one database 270. The linking system 205, the source content provider 245, the client 240 and the target content provider 255 may be communicatively coupled with one another via at least one network 230. The linking system 205 may include at least one request handler 210, at least one link evaluator 215, at least one redirection controller 220, and at least one response provider 225. The linking system 205 may be communicatively coupled to the database 270. The database 270 may include at least one encoded link 265A-N (hereinafter generally referred to as encoded links 265). The source content provider 245 may include at least one source webpage 250. The target content provider 255 may include at least one target webpage 260. Each of the components in the system 200 (e.g., the linking system 205, the source content provider 245, the client 240, and the target content provider, and their subcomponents) may be executed, processed, or implemented using hardware or a combination of hardware and software, such as the system 900 detailed herein in Section C. The system 200 may include one or more of the components of system 100 and its functionalities as detailed herein in Section A.

The client 240 may include a computer or other electronic device capable of communicatively coupling with the network 230 and including an interface to facilitate interaction with webpages. For example, the client 240 may include any of a smartphone, tablet, computer, smart TV, or gaming console. The client 240 may be capable of communicatively coupling with the network 230 via a wired connection (e.g., ethernet), a wireless connection (e.g., Wi-Fi), or a mobile network (e.g., 4G, 5G). The client 240 may include a built-in interface (e.g., touch screen, display) or an external interface (e.g., monitor) configured to facilitate interaction between a user and one or more webpages.

The source content provider 245 may include servers or other computing devices associated with a content provider entity to host and provide the source webpage 250. The source webpage 250 may include, for example, a webpage with content (e.g., textual, graphic, and multimedia content) to be presented to a client 240 communicatively coupled via the network 230. The content provider entity may correspond to an administrator for a website via which the source webpage 250 is accessible. The source content provider 245 and the source webpage 250 can be uniquely referenced via a corresponding URL. The source webpage 250 may include an encoded link (e.g., URL) configured to redirect the client 240 from the source webpage 250 to the target webpage 260 via the linking system 205. The encoded link may correspond to one of the encoded links 265 of the database 270.

The linking system 205 may include servers or other computing devices to process requests for redirection from one webpage to another webpage responsive to an interaction with an encoded link. The linking system 205 may include the request handler 210 to receive requests for redirection, the link evaluator 215 to identify the target webpage 260 based on the encoded links 265 and analyze the content of the target webpage, the redirection controller 220 to select to provide one of a preview interstitial or redirection to a target webpage 260, and the response provider 225 to transmit a message including the preview interstitial element or redirection to the target webpage 260, among others. The linking system 205 may include the database 270 or may have access to the database 270 (e.g., via the network 230). The database 270 may include memory configured to store the encoded links 265. Each of the request handler 210, the link evaluator 215, the redirection controller 220, and the response provider 225 may include at least one processing unit, server, virtual server, circuit, engine, agent, appliance, or other logic device such as programmable logic arrays to perform the computer-readable instructions. The linking system 205 may include or otherwise incorporate any components of the linking system 120.

The target content provider 255 may include servers or other computing devices associated with a content provider entity to host and provide the target webpage 260. The target webpage 260 may include, for example, a webpage with content (e.g., textual, graphic, and multimedia content) to be presented to a client 240 communicatively coupled via the network 230. The content provider entity may correspond to an administrator for a website via which the target webpage 260 is accessible. The target content provider 255 and the source webpage 250 can be uniquely referenced via a corresponding URL. The target webpage 260 may include an encoded link (e.g., URL) configured to redirect the client 240 from the target webpage 260 to another webpage via the linking system 205. The encoded link may correspond to one of the encoded links 265 of the database 270.

The database 270 may store and maintain the set of encoded links 265. The encoded links 265 may correspond to the encoded URL 111. Each encoded link 265 may provide a shortened version of a link to a digital resource (e.g., webpage, web file, search engine). The database 270 may store information about the encoding of the encoded link 265 and the associated link to the digital resource. For example, the database 270 may store, in memory, an association between an encoded link 265 and a target webpage 260. As new encoded links 265 are created, the database 270 may be updated by the network 230 to allocate memory to an association between the encoded links 265 and their respective digital resource.

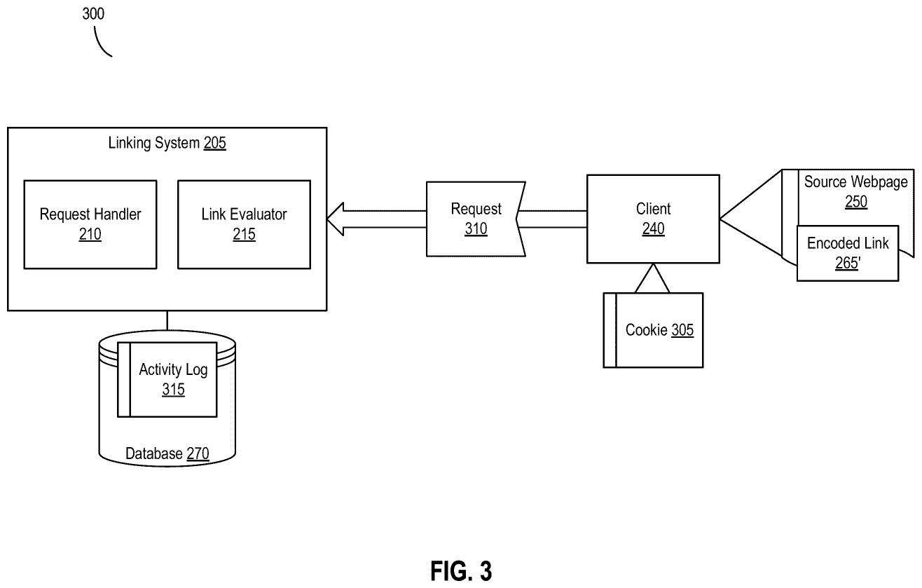

Referring now to FIG. 3, depicted is a block diagram of a process 300 for logging requests for redirection, responsive to an interaction with an encoded link, of the system 200 for redirecting a client from a source webpage to a target webpage. Under the process 300, the client 240 may send, provide, or otherwise transmit at least one request 310 to access the target webpage 260, in response to an interaction with an encoded link 265′ on the source webpage 250. The client 240 may interact with the encoded link 265′ by a user of the client interacting with the encoded link 265′. The encoded link 265′ may have been generated by the linking system 205 using an original resource identifier (e.g., URL) referencing the target content provider 255 and the target webpage 260. The encoded link 265′ may redirect the client 240 through the linking system 205 to access the target webpage 260. For example, the client 240 may be a laptop computer, and the user may interact with the encoded link 265′ by clicking on the encoded link 265′. The client 240 may be configured to display the source webpage 250. The source webpage 250 may include the encoded link 265′.

The request 310 may be associated with a cookie 305 maintained on the client 240. The cookie 305 may be stored or otherwise retained on the client 240 responsive to interaction with the encoded link 265′. The cookie 305 may include information associated with the browsing data of the client 240 in accessing encoded links generated by the linking system 205. For example, upon a first client interaction with the encoded link 265′, the linking system 205 may store the cookie 305 on the client 240. When the client 240 interacts with the encoded link 265′ subsequent times, the cookie 305 may be transmitted back to the linking system 205. The cookie 305 may include information including the number of times the client has interacted with the encoded link 265′. The cookie 305 may also include a total number of client 240 interactions with the encoded links 265. The cookie 305 may also include information relating to the client 240 experience when interacting with encoded links 265 (e.g., responses to previous requests).

The request handler 210 may retrieve, identify, or otherwise receive the request 310 from the client 240. The request handler 210 may log the request in an activity log 315 of the database 270. The activity log 315 may include information relating to requests transmitted by the client 240 or a plurality of clients. The activity log 315 may include information relating to requests transmitted in response to interaction with the encoded link 265′ or the encoded links 265. The request handler 210 may parse the activity log 315 to identify or otherwise determine a proper location in memory to store data of the request 310. For example, the request handler 210 may store the request 310 in two locations of the activity log 315: an allocated location of memory dedicated to client 240 interactions, and an allocated location of memory dedicated to encoded link 265′ interactions for a plurality of users.

The request handler 210 may retrieve, identify, or otherwise receive the cookie 305 of the request 310 associated with the client 240. The request handler 210 may determine or otherwise identify, based on the cookie 305, a number of client 240 interactions with the encoded link 265′. The request handler 210 may store the number of client 240 interactions with the encoded link 265′ in the activity log 315. The request handler 210 may determine or otherwise identify, based on the cookie 305, a number of client 240 interactions with the encoded links 265. The request handler 210 may store the number of client 240 interactions with the encoded links 265 in the activity log 315. The request handler 210 may send or otherwise transmit request information (e.g., the shortened URL of the encoded link) to the link evaluator 215.

With receipt, the link evaluator 215 may identify or select at least a subset of tiers to check the request 310. The tiers may correspond to criteria that determine the proper response to the request 310. As a non-limiting example, tiers may be related to any content associated with the request 310, a content type associated with the request 310, an account type of the client 240, data stored in the activity log 315 (e.g., a number of interactions with the encoded link 265′, previous responses to interactions with encoded links 265 for the client 240). The tiers may be selected in any order and in any configuration. In some embodiments, the link evaluator 215 may select the tiers based on data (e.g., cookie, encoded link 265′, client 240 data) of the request 310.

The link evaluator 215 may identify or otherwise determine the target webpage 260 to be accessed via redirection based on the encoded link 265′ associated with the request 310. For example, the link evaluator 215 may parse the domain of the encoded link 265′ to identify the target content provider 255 and the path of the encoded link 265′ to determine the target webpage 260. The link evaluator 215 may determine the target webpage 260 by searching for components of the encoded link 265′ in memory storage of the database 270. For example, the link evaluator 215 may match or otherwise associate the encoded link 265′ to a known link stored in the database 270. The database 270 may be updated to store more encoded links 265 as they are created or otherwise generated.

The link evaluator 215 may calculate, generate, or otherwise determine a metric indicating a degree of risk from presentation of the target webpage 260. The link evaluator 215 may extract or otherwise determine information (e.g., content category, safety score) of the target webpage 260. The link evaluator 215 may be configured to detect safety risks (e.g., malware, scams) of the target webpage 260. The risk metric may be determined based on one or more risk characteristics of the target webpage 260. For example, the risk characteristics may be based on the information of the target webpage 260 extracted by the link evaluator 215. For example, if the target webpage 260 has a content category that is deemed risky (e.g., sensitive content, content falling in abuse categories, or public safety content), the link evaluator 215 may determine a high degree of risk. As another example, if the link evaluator 215 determines that the target webpage 260 likely contains malware, the link evaluator 215 may determine a high degree of risk.

In some embodiments, the link evaluator 215 may examine, inspect, or otherwise determine a type of content requested by the client 240 in a header of the request 310. The link evaluator 215 may inspect a HTTP request header and determine a type of content requested by the client 240 for the request 310. For example, the HTTP request header may indicate that the request 310 requests a response with an image file. As another example, the HTTP header may indicate that the request 310 requests (e.g., expected by the client 240) a response with HTML content (e.g., a webpage). In some embodiments, the link evaluator 215 may identify or determine an account type for the target content provider 255. The request 310 may include information associated with the target content provider 255, including subscription information. The subscription information may indicate whether the target content provider 255 includes a paid account or a free account. The database 270 may include subscription information for content providers (e.g., the target content provider 255), accessible by the link evaluator 215.

The link evaluator 215 may calculate, generate, or otherwise determine a metric indicating a degree of frequency of visits to the target webpage 260 via the encoded link 265′. The database 270 may include information indicating a total number of requests for the encoded link 265′, accessible to the link evaluator 215. The total number of requests may be based on the client 240 or across a plurality of clients. The link evaluator 215 may compare the total number of requests to a predetermined request frequency threshold to determine whether the encoded link 265′ has a high degree of frequency or a low degree of frequency. For example, if the total number of requests is above the request frequency threshold, the target webpage 260 may have a high degree of frequency. Conversely, if the total number of requests is below the request frequency threshold, the target webpage 260 may have a low degree of frequency. In some embodiments, the link evaluator 215 may calculate, generate, or otherwise determine a metric indicating a degree of frequency of preview interstitial elements presented to the client 240. The cookie 305 of the request 310 may include request data indicating client 240 interactions with encoded links 265 during a browsing session. The request data may indicate responses to previous requests, including the number of times the client 240 has been presented with a preview interstitial element.

In some embodiments, the link evaluator 215 may calculate, generate, or otherwise determine a metric indicating a number of visits by the client 240 to the target webpage 260 based on the activity log 315. The activity log 315 associated with the client 240 may identify visits to different webpages through encoded links 265 of the linking system 205. In some embodiments, the link evaluator 215 may determine whether the client 240 was provided or presented with a preview interstitial element previously based on the activity log 315. The activity log 315 associated with the client 240 may identify presentations of preview interstitial elements from the linking system 205 upon interaction with encoded links 265.

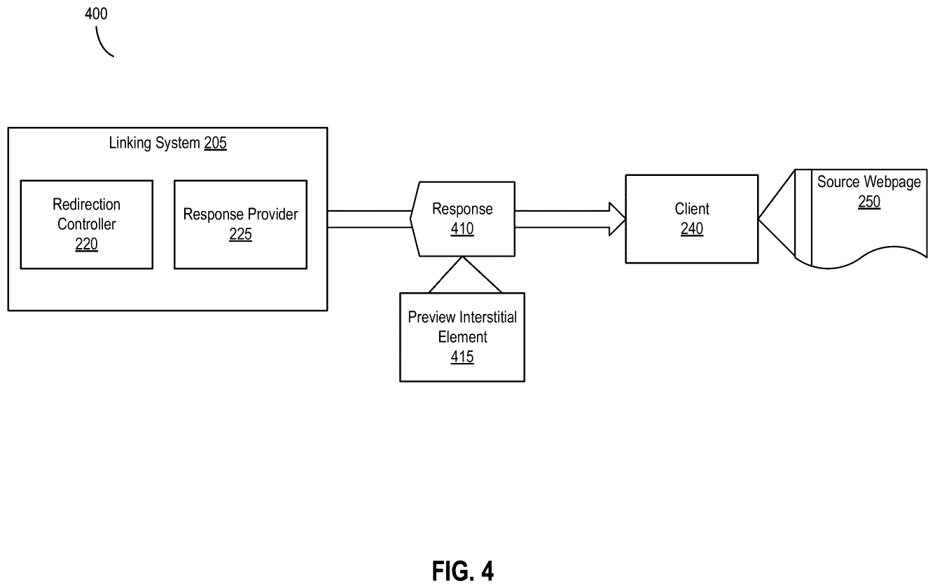

Referring now to FIG. 4, depicted is a block diagram of a process 400 for providing a response to a request for redirection from a source webpage to a target webpage of the system 200, where the response includes providing a preview interstitial element. Under process 400, the redirection controller 220 may identify or select whether to provide a preview interstitial element 415 (sometimes herein referred to as a preview element or an interstitial element) or the target webpage 260 based on the determinations by the link evaluator 215. The redirection controller 220 may process the determinations of the link evaluator 215 for each tier evaluated by the link evaluator 215, to determine whether the tier indicates providing the preview interstitial element 415 or redirection to the target webpage 260. In some embodiments, the redirection controller 220 may determine to provide preview interstitial element 415 in accordance with the checks specified by the tiers (or any combination of the tiers). For example, the tiers may include comparing the risk metric against a threshold and comparing a metric indicating frequency of visits against a frequency threshold.

The redirection controller 220 may dynamically determine whether the client 240 should be redirected immediately to the target webpage 260 via the encoded link 265 or presented with the preview interstitial element 415 for the target webpage 260, incorporating multi-tiered, algorithmic logic to make that determination. This decision process may aim to achieve a balance between seamless user experience, increased trust in the encoded links visited, and targeted content opportunities. The redirection controller 220 may utilize a multi-tiered decision process to determine whether the preview interstitial element 415 should be displayed to a user instead of immediately redirecting the user to the target webpage when they engage with the encoded link 265. Each tier may consider a number of factors. The redirection controller 220 may incorporate algorithmic logic to control the frequency of preview page displays based on target URL content, encoded link click counts, and user session data, among others. This logic can dynamically adjust the percentage of visits that trigger preview page display.

Under tier 1, the redirection controller 220 may use content category and trust and safety score appropriateness. The redirection controller 220 may evaluate the content category and trust & safety score of the target webpage (or URL). If the category is deemed inappropriate for preview display (e.g., sensitive content, content falling in abuse categories, public safety, or non-profit content), the user may be (1) blocked from reaching the target URL if the content is deemed malicious or unsafe based on its Trust & Safety classification and score, (2) presented with a “Warning” interstitial page if the content is deemed “potentially unsafe,” but the user can still click through to the target URL, or (3) presented with a Preview Page for that target URL if the subsequent decision tiers deem such display is warranted.

Under tier 2, the redirection controller 220 may factor HTTP Request Validation. The redirection controller 220 may inspect the HTTP request headers to ensure that the request is appropriate for returning HTML content. If the request indicates a non-HTML response is expected (e.g., image, video), the user may be directly redirected. Under tier 3, the redirection controller 220 may use the account type of link encoder 110 (e.g., target content provider). The redirection controller 220 may check the type of account that created the encoded link for. For instance, free accounts might be subject to preview pages more frequently than paid accounts.

Under tier 4, the redirection controller 220 may use click count thresholds. The redirection controller 220 may track the number of times a specific URL has been clicked. After reaching a predefined threshold, the redirection controller 220 may begin selecting the displaying of a preview page for a percentage of subsequent visits to the same URL. Under tier 5, the redirection controller 220 may use the recent preview page display. The redirection controller 220 may track whether a user has recently been presented with a preview page for the given short link or for any short link. This may prevent the user from repeatedly seeing preview pages during a single session. This tier may use browser cookies to track user interactions. Under Tier 6, the redirection controller 220 may use a preview page with or without content item display. In some cases, even if it is deemed desirable to show the user a preview page, some content categories may not be appropriate for displaying content items (e.g., ad content). A final assessment may be made based on the content category to determine whether to display ad content beside the preview page's “preview content” about the target URL. The “preview content” may include information about the target URL, such as the page title, page description, or page search term (e.g., search engine optimization (SEO)) keywords, among others.

When the risk metric does not exceed the risk threshold, the redirection controller 220 may select the preview interstitial element 415 instead of the target webpage 260. In some embodiments, the risk metric not exceeding (e.g., being below) the risk threshold may indicate that the target webpage 260 is appropriate for preview display. For example, if the target webpage 260 has a low-risk metric, it likely does not contain sensitive content and is therefore appropriate for preview interstitial element 415 display. The redirection controller 220 may select the content of the preview interstitial element 415 based on the risk metric. For example, if the target webpage 260 has a certain risk metric and is deemed “potentially unsafe,” a preview interstitial element may be displayed to warn the user of potential dangers associated with the target webpage. As another example, if the target webpage 260 has a certain risk metric and is deemed “safe,” a preview interstitial element may be displayed to include information about the target webpage 260.

When the request headers of the network 230 are of a valid type, the redirection controller 220 may select the preview interstitial element 415 instead of the target webpage 260. A valid type of request header may include HTTP request headers that indicate a HyperText Markup Language (HTML) response with a particular content type. A HTML response is a type of response that contains HTML code, which is used to create and structure webpages. For example, if the request headers indicate that the encoded link 265′ is associated with a webpage, the redirection controller 220 may select the preview interstitial element 415. If the HTTP request headers indicate a non-HTML response (e.g., as would be expected with an image file, video file, or other document), the preview interstitial element 415 may not be selected.

When the account type of the target content provider 255 is of a certain type, the redirection controller 220 may select the preview interstitial element 415 instead of the target webpage 260. For example, if the account type of the target content provider 255 is a free (e.g., not subscribed, unlicensed, non-premium) account, the redirection controller 220 may select the preview interstitial element 415. In some instances, even if the account type of the target content provider 255 is a paid (e.g., subscribed, licensed, premium) account, the redirection controller 220 may select the preview interstitial element 415. However, generally, the redirection controller 220 may select preview interstitial elements 415 for paid accounts less frequently than for free accounts. The determination to select the preview interstitial element 415 based on account type may involve further determinations of account characteristics such as client 240 activity.

When the frequency of visits to the target webpage 260 (e.g., across the clients) exceeds a visit frequency threshold, the redirection controller 220 may select the preview interstitial element 415 instead of the target webpage 260. The visit frequency may be based on the number of interactions with the encoded link 265′ by a plurality of clients. For example, the visit frequency may be a number of interactions with the encoded link 265′ in a predetermined amount of time. The visit frequency threshold may be based on a minimum number of encoded link 265′ interactions that would deem the encoded link 265′ frequently interacted with.

Selecting the preview interstitial element 415 in cases where the visit frequency exceeds the visit frequency threshold may allow for targeting preview interstitial elements 415 to encoded links 265 that are frequently interacted with.

When the frequency or number of visits by the client 240 exceeds the client visit frequency threshold, the redirection controller 220 may select the preview interstitial element 415 instead of the target webpage 260. In some embodiments, the frequency of visits by the client 240 may be based on a number of interactions between the client 240 and the encoded link 265′ in a predetermined period. In alternate embodiments, the frequency of visits by the client 240 may be based on a number of interactions between the client 240 and the plurality of encoded links 265. In some embodiments, the predetermined period may be a single web-browsing session. The client visit frequency threshold may be based on a minimum number of interactions between the client 240 and the encoded links 265 that would deem the client 240 as a frequent visitor. In some embodiments, the redirection controller 220 may select the preview interstitial element 415 instead of the target webpage 260 when the determination is that the client 240 was not previously provided with another interstitial elements.

In some embodiments, with the determination of whether to provide the preview interstitial element 415 or redirect the client 240, the redirection controller 220 may cache or store the determination and relevant factors for the determination. The factors may include, for example, a tier, validation of HTTP request, request header, content category, trust and safety score, the metric indicating a degree of risk, the metric indicating a frequency of visits, the metric indicating a frequency of preview interstitial elements, or the account type, among others. The determination and the relevant factors may be stored and maintained on the database 270, using one or more data structures, such as an array, a linked list, a tree, a queue, a stack, a matrix, a heap, a hash, a table, or a data object, among others. The determination and the relevant factors may be stored for subsequent determinations for future requests (e.g., in a similar form as the request 310), to allow the performance of such determinations to occur within a short period of time (e.g., 10-100 ms).

In some embodiments, when the request 310 is received, the redirection controller 220 may extract or identify factors for the request 310 to determine whether to provide the preview interstitial element 415 or to redirect the client 240 to the target webpage 260. Using the identified factors, the redirection controller 220 may perform a search for previous determinations on the database 270. If the factors for the request 310 do not correspond to any of the relevant factors in the previous determinations, the redirection controller 220 may perform a new determination (e.g., as described herein). On the other hand, if the factors for the request 310 correspond to the relevant factors of at least one of the previous determinations, the redirection controller 220 may apply the previous determination to the current determination. When the previous determination is to provide the preview interstitial element 415, the redirection controller 220 may determine to provide the preview interstitial element 415 to the client 240 associated with the request 310. Conversely, when the previous determination is to redirect the client 240, the redirection controller 220 may determine to provide an instruction to redirect the client 240 to the target webpage 260.

When the redirection controller 220 selects to provide the preview interstitial element 415, the redirection controller 220 may select, identify, or otherwise determine the contents of the preview interstitial element 415. In some embodiments, the preview interstitial element 415 may include a warning preview interstitial configured to alert the client 240 that the target webpage 260 includes content that is potentially unsafe. In some embodiments, the preview interstitial element 415 may include information about the target webpage 260. For example, the preview interstitial element 415 may include any of a page title, description (e.g., summarization of or a portion from the target webpage 260), and keywords, among others. The preview interstitial element 415 may include keywords indicating a category of media, such as business or science, among others, used for search engines. In some embodiments, the preview interstitial element 415 may include a content item (e.g., including text, image, or audio, or any combination thereof). The content item may be based on characteristics of the client 240, such as web-browsing history and/or the target webpage 260. The determination to present the content item may be based on a content category of the target webpage 260. For example, if the target webpage 260 includes sensitive content, the redirection controller 220 may choose not to include the content item.

The redirection controller 220 may create, produce, or otherwise generate the preview interstitial element 415 to be displayed on the client 240. The preview interstitial element 415 may include a script to be read by the client 240 to display content. The script for the preview interstitial element 415 may be, for example, in HyperText Markup Language (HTML), Cascading Style Sheets (CSS), or Javascript, among others. The preview interstitial element 415 may be to preview at least a portion of the target webpage 260. The preview interstitial element 415 may be displayed subsequent to interaction with the encoded link 265′ and prior to redirection to the target webpage 260. The preview interstitial element 415 may be configured to be displayed on any of a computer screen, smartphone, tablet, or other web-connected device. The redirection controller 220 may generate the preview interstitial element 415 based on characteristics of the client 240, such as device type, network connectivity strength, or other capabilities of the client 240. For example, if the client 240 is a smartphone, the generated preview interstitial element 415 may have smaller dimensions than a preview generated for a laptop computer. As another example, if the client 240 has a weak internet connection, the generated preview interstitial element may not include high-definition video content.

The preview interstitial element 415 may preview one or more portions of the target webpage 260. The preview interstitial element 415 may include, for example, one or more of: warning indicator, information about the target webpage 260 (e.g., a page title, page description, or keywords), content items (e.g., text, image, audio, or any combination thereof), among others. The warning indicator may include an indication of presence of sensitive or flagged content on the target webpage 260. The page title may, for example, correspond to a title of the target webpage 260 (e.g., from a title tag of the script for the target webpage 260. The page description may, for instance, include a summarization (e.g., generated using natural language processing (NLP)) or a portion (e.g., paragraphs from text) of the target webpage 260). The keywords may include, for example, page search terms (e.g., search engine optimization (SEO)) associated with the target webpage 260.

In some embodiments, the redirection controller 220 may generate the preview interstitial element 415 to include a user interface element. The user interface element may cause the client 240 to be redirected to the target webpage 260, in response to a user interaction (e.g., mouse click, tap screen, or another event) with the user interface element. The user interface element may include the target URL corresponding to the target webpage 260. In some embodiments, the user interface element may have a timer to keep track of a length of time relative to providing (e.g., displaying on the source webpage 250) the preview interstitial element 415. The user interface element may initially be disabled or deactivated for a predefined time delay (e.g., between 5-30 seconds). Subsequent to elapsing of the predefined time delay, the user interface element may be enabled or activated to permit redirection of the client 240 to the target webpage 260 responsive to the user interaction with the user interface element. In some embodiments, the time delay may correspond to a time length of other content (e.g., an audio or video content item) of the preview interstitial element 415. When the time length of other content has elapsed, the user interface element of the preview interstitial element 415 may be enabled or activated to permit redirection of the client 240 to the target webpage 260 responsive to the user interaction with the user interface element.

The response provider 225 may send or otherwise transmit at least one response 410 to the network 230 to the client 240. The response 410 may include the generated preview interstitial element 415. The response 410 may also include computer-executable instructions to display the preview interstitial element 415 on the source webpage 250 of the client 240. The response 410 may include a cookie to be maintained by the client 240 that includes an updated number of user interactions with the encoded link 265′ and/or encoded links 265. The cookie may include an updated number of preview interstitial elements 415 transmitted from the linking system 205 to the client 240.

Upon receipt of the response 410, the client 240 may execute the computer executable instructions to display the preview interstitial element 415 on the source webpage 250. The preview interstitial element 415 may be displayed on the source webpage 250 such that the content of the source webpage 250 may be inaccessible while the preview interstitial element 415 is displayed. For example, the preview interstitial element 415 may be displayed in the same tab as the source webpage 250. Other characteristics common to web browsers, such as a back button (e.g., allows you to visit the previous webpage) and/or a forward button (e.g., allows you to visit the next webpage), may be disabled while the preview interstitial element 415 is displayed.

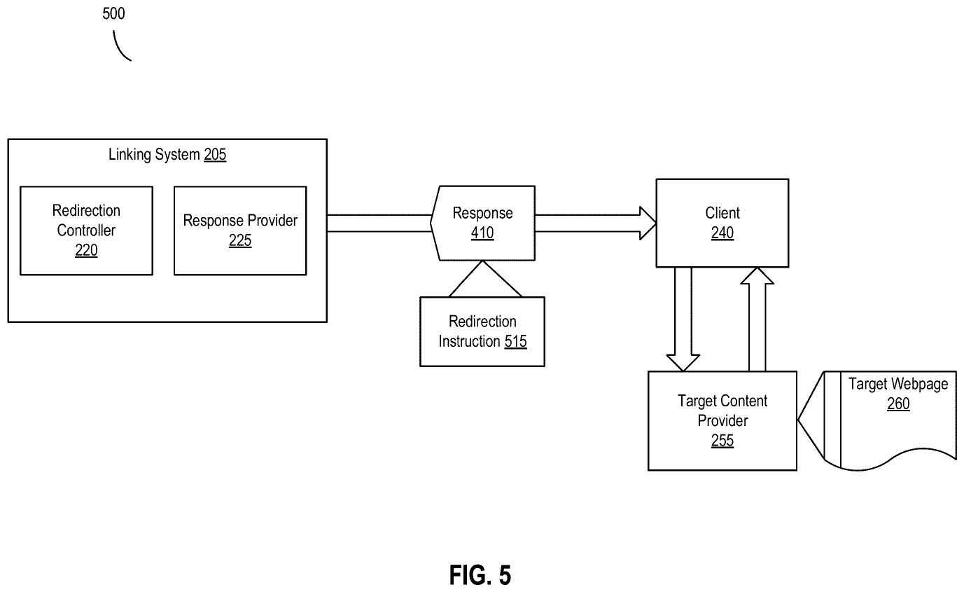

Referring now to FIG. 5, depicted is a block diagram of a process 500 for providing a response to a request for redirection from a source webpage to a target webpage, where the response includes redirection to the target webpage. Under process 500, the redirection controller 220 may identify or select the target webpage 260 instead of the preview interstitial element 415 based on the determinations by the link evaluator 215. The redirection controller 220 may process the determinations of the link evaluator 215 for each tier evaluated by the link evaluator 215, to determine if the tier indicates providing a redirection instruction 515 to the client 240.

When the risk metric exceeds the risk threshold, the redirection controller 220 may select the redirection instruction 515 instead of the preview interstitial element 415. In some embodiments, the risk metric exceeding the risk threshold may indicate that the target webpage 260 is not appropriate for preview display. For example, if the target webpage 260 has a high-risk metric, it likely contains sensitive content and is therefore inappropriate for preview interstitial element 415 display. The redirection instruction 515 may be based on the risk metric. For example, if the target webpage 260 has a risk metric that is too high for preview interstitial display, but still low enough for redirection, the redirection instruction 515 may redirect the client 240 to the target webpage 260. As another example, if the target webpage 260 has a risk metric indicating that the client 240 should not be exposed to the content of the target webpage 260, the redirection instruction 515 may be configured to redirect the client 240 to a “restricted page,”where the client 240 is unable to access the target webpage 260.

When the request headers of the network 230 are not of a valid type, the redirection controller 220 may select the redirection instruction 515 instead of the preview interstitial element 415. An invalid type of request may include request headers that do not indicate an HTML response. For example, if the request headers indicate that the encoded link 265′ is associated with an image or video file, the redirection controller 220 may select the redirection instruction 515 instead of the preview interstitial element 415.

When the account type of the client 240 is of a certain type, the redirection controller 220 may select the redirection instruction 515 instead of the preview interstitial element 415. For example, if the account type of the target content provider 255 is a paid (e.g., subscribed, licensed, premium) account, the redirection controller 220 may select the redirection instruction 515. In some instances, even if the account type of the target content provider 255 is a free account, the redirection controller 220 may select the redirection instruction 515. However, generally, the redirection controller 220 may select the redirection instruction 515 for free accounts less frequently than for paid accounts. The determination to select the redirection instruction 515 based on account type may involve further determinations of account characteristics such as client 240 activity.

When the frequency of visits to the target webpage 260 via the encoded link 265′ does not exceed the visit frequency threshold, the redirection controller 220 may select the redirection instruction 515 instead of the preview interstitial element 415. Selecting the redirection instruction 515 in cases where the visit frequency does not exceed the visit frequency threshold may allow for targeting preview interstitial elements 415 to encoded links 265 that are frequently interacted with. Since encoded links 265 with low visit frequency receive less client 240 traffic, it may not be advantageous to present preview interstitial elements 415. When the frequency or number of visits by the client 240 to the target webpage 260 does not exceed a threshold, the redirection controller 220 may select the redirection instruction 515 instead of the preview interstitial element 415. In some embodiments, the frequency or number of visits by the client 240 may be based on a number of interactions between the client 240 and the encoded link 265′ in a predetermined period. In alternate embodiments, the frequency of visits by the client 240 may be based on a number of interactions between the client 240 and the plurality of encoded links 265. In some embodiments, the predetermined period may be a single web-browsing session. The threshold may be based on a minimum number of interactions between the client 240 and the encoded links 265 that would deem the client 240 as a frequent visitor. In some embodiments, the redirection controller 220 may select the target webpage 260 instead of the preview interstitial element 415, when the determination is that the client 240 was previously provided with another interstitial elements.

The redirection controller 220 may create, produce, or otherwise generate a redirection instruction 515 to redirect the client 240 to the target webpage 260. The redirection instruction 515 may include computer executable instructions configured to exit the source webpage 250. The computer-executable instructions may include an instruction to be transmitted from the client 240 to the target content provider 255 configured to load the target webpage 260 on the client. The response provider 225 may send or otherwise transmit a response 410 to the network 230 to the client 240. The response 410 may include the computer executable instructions. The response 410 may include a cookie to be maintained by the client 240 that includes an updated number of client interactions with the encoded link 265′ and/or encoded links 265. The cookie may include an updated number of redirection instructions 515 transmitted from the linking system 205 to the client 240.

Upon receipt of the response 410, the client 240 may execute the redirection instruction 515 to display the target webpage 260. The target webpage 260 may be displayed on the client 240 responsive to a communication between the client 240 and the target content provider 255. The communication may include a request from the client 240 for the target webpage 260 and a response from the target content provider 255 including the target webpage 260. The target webpage 260 may be displayed on the client 240 such that the source webpage 250 is still accessible using common web-browser features such as the back button.

In this manner, by determining whether to redirect the client 240 to the target webpage 260 or select the preview interstitial element 415, the linking system 205 may manage the allocation of computing resources (e.g., processor and memory) and network bandwidth in an efficient fashion. For example, from performing the checks specified by the tiers, the linking system 205 may control the frequency or rate at which the preview interstitial element 415 is selected for provisioning to users. This may prevent providing the preview interstitial element 415 too often, which can lead to a decrease in the likelihood of user interaction with the preview interstitial element 415. The controlling of the frequency may thus serve to improve the quality of human-computer interactions (HCI) between the user and the client 240. By selectively provisioning preview interstitial elements 415, the linking system 205 may counter loss of efficiency for the client 240 from wasted consumption of computing resources that would have otherwise been incurred from providing content with little to no likelihood of interaction. In addition, caching previous determinations regarding whether to provide the preview interstitial element 415 or to redirect the client 240 may reduce the number of redundant computations on the part of the linking system 205 as well as improve HCI by providing a seamless user experience on the part of the user of the client 240.

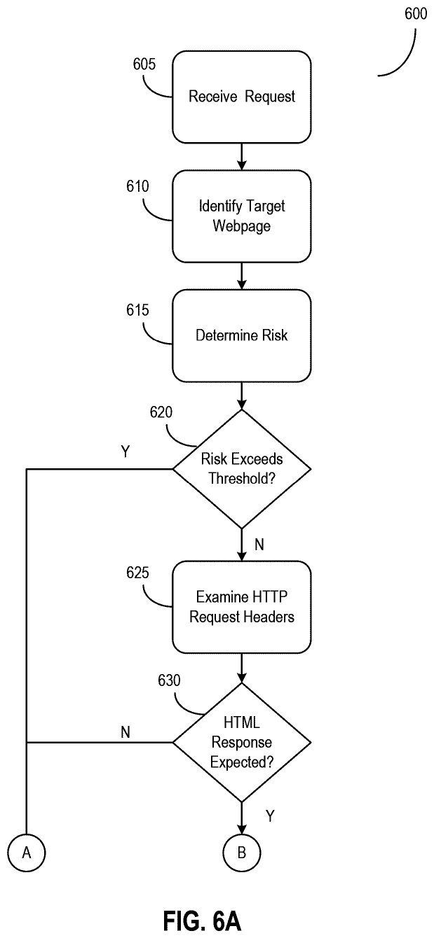

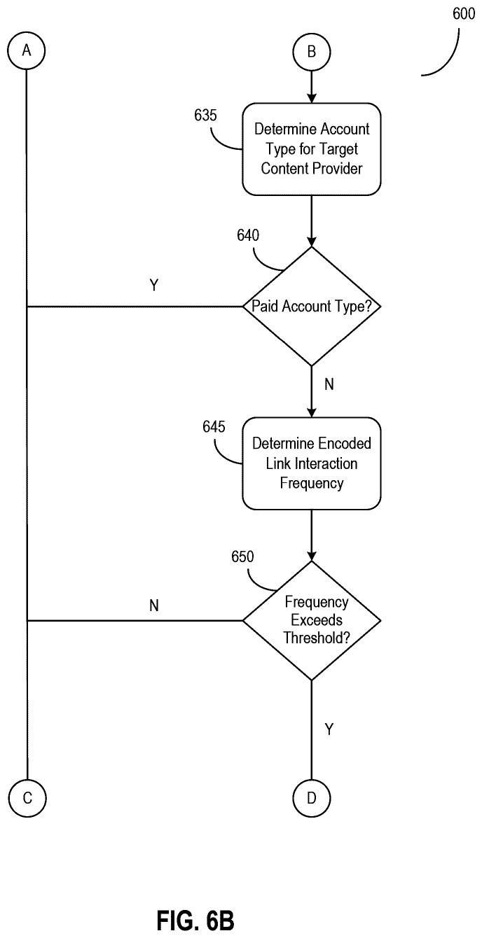

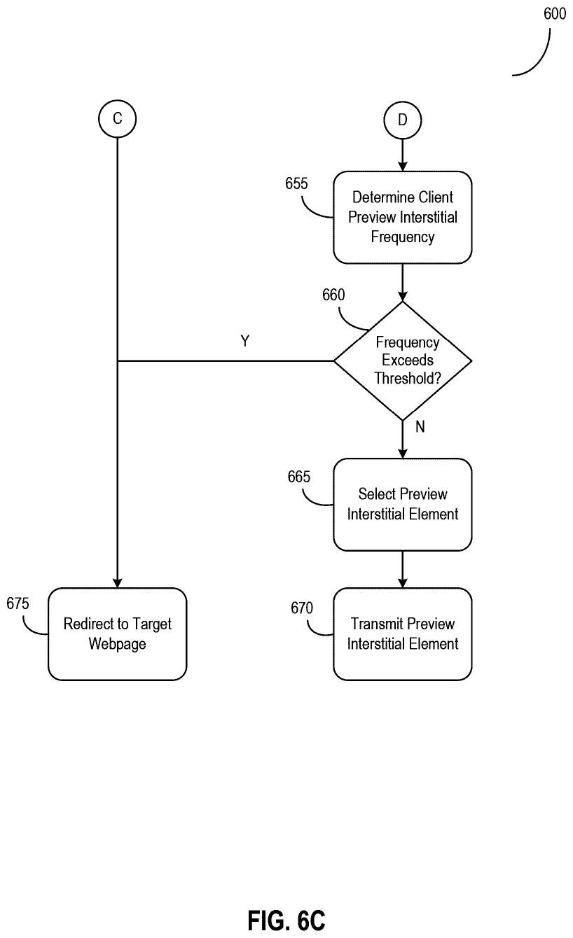

Referring generally to FIGS. 6A-6C, depicted is a flow diagram of a multi-tiered process 600 for receiving, processing, and providing a response to the network 230 for redirection from a source webpage 250 to a target webpage 260. Referring to FIG. 6A, at step 605, the linking system 205 may receive or otherwise acquire a network 230 for redirection from the source webpage 250 to the target webpage 260. The network 230 may be responsive to an interaction between the client 240 and the encoded link 265′ of the source webpage 250. At step 610, the linking system 205 may identify or otherwise determine the target webpage 260 based on the received network 230. The network 230 may be identified by the link evaluator 215, responsive to associating the encoded link 265′ with an encoded link of the database 270.

At step 615, the linking system 205 may calculate, generate, or otherwise determine a risk metric based on the content associated with the target webpage 260. The risk metric may be determined by the link evaluator 215, responsive to a determination of the content associated with the target webpage 260. At step 620, the linking system 205 may select or otherwise determine whether the risk metric exceeds a risk threshold. The risk threshold may be based on a minimum amount of risk that deems the target webpage 260 inappropriate for preview display. The determination of whether the risk metric exceeds the risk threshold may be made by the link evaluator 215, responsive to a comparison of the risk metric to the risk threshold.

At step 625, if the risk metric does not exceed the risk threshold, the linking system 205 may examine or otherwise analyze the HTTP request headers of the network 230.

The link evaluator 215 may examine the HTTP request headers to determine if a HTML (e.g., webpage) response is expected. At step 630, the linking system 205 may determine, detect, or otherwise identify whether a HTML response is expected based on the HTTP request headers. A HTML response may indicate that the network 230 is associated with a webpage, and not a different media type (e.g., image file, video file, document).

Referring now to FIG. 6B, depicted is a partial flow diagram of the multi-tiered process 600, specifically referring to processing the network 230 based on account type and encoded link 265′ interactions. At step 635, if an HTML response is expected based on the HTTP request headers, the linking system 205 may identify, detect, or otherwise determine an account type for the target content provider 255. The account type may be identified by the link evaluator 215 and may indicate whether the target content provider 255 is a paid account (e.g., purchased via subscription and/or license) or a free account.

At step 640, the linking system 205 may identify, detect, or otherwise determine whether the account type of the target content provider 255 is a paid account or a free account. The link evaluator 215 may identify the account type based on content provider information included in the database 270. At step 645, if the account type of the target content provider 255 is determined to not be a paid account type (e.g., free), the linking system 205 may determine an encoded link interaction frequency. In some embodiments, the encoded link interaction frequency may be based on a frequency of the client 240 interacting with the encoded link 265′. In other embodiments, the encoded link interaction frequency may be based on a frequency of the client 240 interacting with the encoded links 265. At step 650, the linking system 205 may determine or otherwise select whether the encoded link 265′ interaction frequency exceeds an interaction frequency threshold. The interaction frequency threshold may be based on a minimum number of client 240 visits that would determine the client 240 to be a frequent visitor.

Referring now to FIG. 6C, depicted is a partial flow diagram of the multi-tiered process 600, specifically referring to processing the request based on the frequency of client 240 interactions with preview interstitial elements 415, and providing the proper response to the network 230. At step 655, if the encoded link interaction frequency exceeds the interaction frequency threshold, the linking system 205 may calculate, generate, or otherwise determine a metric indicating client preview interstitial frequency. The client preview interstitial frequency may be based on a number of times in a single web-browsing session the client 240 has interacted with preview interstitial elements 415. The client preview interstitial frequency may be based on the number of client 240 interactions with preview interstitial elements 415 for a single encoded link 265′ or the encoded links 265.

At step 660, the linking system 205 may determine, identify, or otherwise select whether the client preview interstitial frequency exceeds a client threshold frequency. The client threshold frequency may be based on a minimum number of client 240 interactions with preview interstitial elements 415 to determine that the client 240 should not interact with additional preview interstitial elements 415. At step 665, if the client preview interstitial frequency does not exceed the client threshold frequency, the linking system 205 may determine or otherwise decide to generate or otherwise select a preview interstitial element 415. The content of the preview interstitial element 415 may be based on the content type of the target webpage 260.

The preview interstitial element 415 may include any of a warning, keywords, or page title associated with the target webpage 260.

At step 670, the linking system 205 may transmit a response 410 including the preview interstitial element 415 to the client 240 for display on the source webpage 250. The client 240 may display the preview interstitial element 415 responsive to receiving the response 410. At step 675, the linking system 205 may decide or otherwise determine that the preview interstitial element 415 may not be appropriate for display to the client 240 and instead redirect the client 240 to the target webpage 260. The redirection may be included in a response 410 transmitted from the linking system 205 to the client 240.

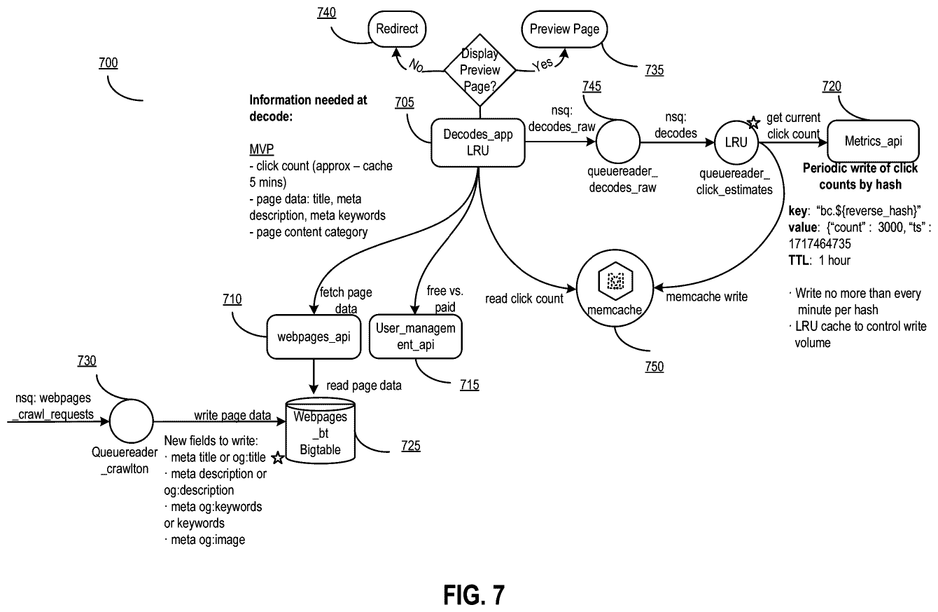

Referring now to FIG. 7, depicted is a system 700 for decoding request and webpage data to make a targeted determination regarding the redirection from a source webpage to a target webpage. In some embodiments, system 700 may include a decoding app 705 configured to receive parameters relating to the client 240 and the target content provider 255 to make determinations. The decoding app 705 may receive information from a webpage application programming interface (API) 710 associated with the target webpage 260. The webpage API 710 may receive information relating to the target webpage 260 from a database 725. The database 725 may include information such as a title, description, keywords, and/or images associated with the target webpage 260. The information of the database 725 may be sourced from a web crawler 730 of the linking system 205. The web crawler 730 may be configured to search the target webpage 260 for information and write the information to the database 725. The decoding app 705 may receive information from a user management API 715 associated with the target content provider 255. For example, the management API 715 may receive information indicating whether the target content provider 255 is a paid (e.g., subscribed, licensed, premium) account or a free (e.g., unpaid) account.

The decoding app 705 may process information received from the webpage API 710, user management API 715, and the metrics API 720 to determine whether to display preview page 735 a preview interstitial element 415 or to redirect 740 to the target webpage 260. The decoding app 705 may make the determination based on any of the tiers of process 400. The decodes app may be configured to complete process 600. For example, based on information received by the decoding app 705 from the webpage API 710, user management API 715, and the metrics API 720, the decoding app 705 may complete process 600.

Internal decode events and downstream services may be unaffected by the presentation of interstitials (e.g., preview interstitial element 415). New events may be created to measure key performance indicators (KPIs) specific to the presentation of ad interstitials.

Changes may be made to decodes (e.g., decoding app 705) based on these factors. These changes may impact consumers (e.g., analytics, data warehouses) of the data (e.g., KPIs).

To monitor the impact of ad interstitials, internal metrics may be recorded. For example, abandonment rate and/or click-through-rate (CTR) may be recorded by the decoding app 705. The CTR may be based on a ratio of preview interstitials redirected to preview interstitials seen. The abandonment rate may be based on a ratio of preview interstitials not redirected to preview interstitials seen. Additional metrics such as views (e.g., clicks, impressions) may be recorded. The decoding app 705 may include a page view event. The page view event may be activated upon the click of a short link (e.g., encoded link 265′). The page view event increments the views metric for a webpage's (e.g., target webpage 260) analytics. The decoding app 705 may include a preview interstitial view event. The preview interstitial view event may be activated by an outbound click of an interstitial page. The preview interstitial view event may increment the view metric for preview interstitials on a webpage.

Events of the decoding app 705 may be categorized as view events or redirect events. For example, the page view event may be categorized as a view event. As another example, the preview interstitial view event may be categorized as a redirect event. View events may be triggered prior to rendering the preview interstitial. Redirect events may be triggered by any of clicking on destination URL (e.g., encoded link 265′), clicking on “continue to destination” button (e.g., redirect button of the preview interstitial element 415), being redirected to the final destination, or abandoning the page. Before displaying the preview interstitial to a visitor (e.g., client 240), the decoding app 705 may send a view event to an event platform (e.g., an Events NSQ). This action may be executed server-side within the decoding app 705 and click handlers.

A new event handler may be created to capture redirects away from or closing the tab page via beacon events. In some embodiments the, redirect request that redirect from the preview interstitial may include a header property. When the header property is set to true, information may be captured by a middleware component responsible for processing redirect events to the event platform.

In some embodiments, two separate decode events may be sent upon the rendering of the page and the rendering of the ad. A new header property may be created to determine the difference between the two decode events and may be filterable depending on the consumer. The decoding logic may be determined at time of redirect within the decoding app 705.

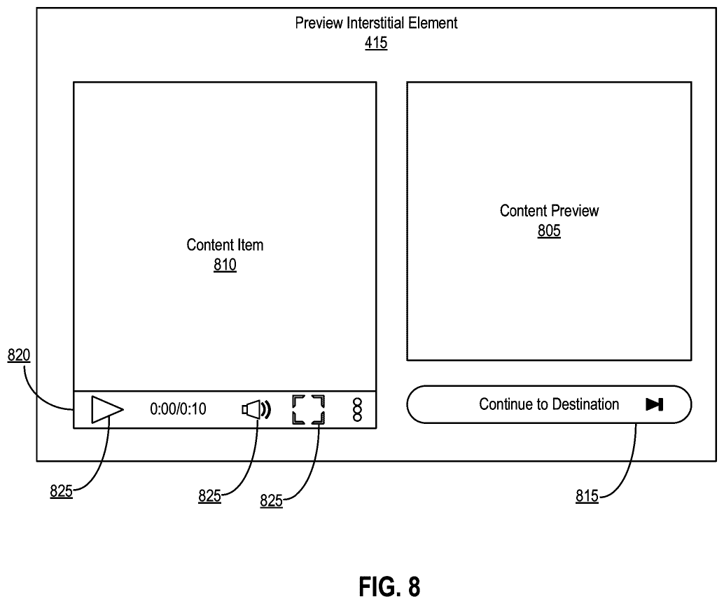

Referring now to FIG. 8, depicted is a preview interstitial element 415, in accordance with one or more embodiments. In some embodiments, the preview interstitial element may include a content preview 805 of the target webpage 260. The content preview 805 may include identifying information for the target webpage 260. For example, the content preview 805 may include any of a URL, a title, a summary, keywords, or a content type of the target webpage 260. The content preview 805 may be omitted based on the risk metric of the target webpage 260. For example, if the target webpage 260 includes sensitive content, the content preview 805 may be omitted to prevent exposure to harmful content.

In some embodiments, the preview interstitial element 415 may include a content item 810. The content item 810 may include digital media (e.g., image, video, text, audio). The content item 810 may include a taskbar 820 configured to interact with the content item 810. The taskbar 820 may include one or more selectable elements 825 configured to perform functions relating to the content item 810. For example, the selectable elements 825 may perform tasks including any of pause, resume, adjust volume, enter/exit full screen, as well as other tasks.

In some embodiments, the preview interstitial element 415 may include a selectable element (e.g., redirect button 815) configured to redirect the client 240 from the preview interstitial element to the target webpage 260. In some embodiments, the redirect button 815 may include a time delay associated with the content item 810 before redirecting to the target webpage 260. For example, if the content item 810 is a ten second video, the redirect button 815 may include a ten second time delay in which the redirect button may not be selectable. As another example, if the content item 810 is an image and/or text, the time delay may be associated with an amount of time that a user would take to interact with (e.g., hover over or click) the content item.

In some embodiments, a preview page (e.g., preview interstitial element 415) may provide an interstitial to display instead of a HTTP 301 redirect to the final destination (e.g., target webpage 260). The preview page may include metadata fetched from the final URL and may allow for links created by accounts (e.g., target content providers 255) on the free tier (e.g., unpaid account). The preview page may allow for leveraging house ads to improve product adoption elsewhere. This implementation may be facilitated by the decoding app 705. The decoding app 705 may determine to render a preview page and record the response as a decode. This may occur after trust and safety checks such that all preview pages may happen in place of a 301 or 302 redirect not in place of other interstitials. The determination to render a preview page may be limited to webpages with a header that indicates that the page is a user-navigation, and a full-page response is acceptable.

In some embodiments, webpages that have a certain URL suffix (e.g., ending in .gov, .edu, or .org) may be excluded form preview display. Links created by accounts in a paid tier may be excluded. Multi-destination links may be excluded, as it would interfere with the ad crawler observing the same response as a user (e.g., client 240). In some embodiments, there may be a way to force or otherwise simulate template responses to bypass the targeting selection. This may be through an administrator page to set a cookie that forces preview page responses. In some embodiments, bot filtering may occur downstream in qr_decodes_raw 745. Additionally, or separately, bot filtering may occur via a matching lookup in the decoding app 705. This may allow the exclusion of bots being presented a preview page.

In some embodiments, runtime criteria may be evaluated in a fixed timeframe (e.g., up to 50ms) for deciding to return a preview page. If the decoding app 705 is unable to retrieve sufficient information to render a decision, the decoding app 705 may default to not showing a preview page. Considerations to be made to render a decision may include webpage metadata (e.g., title, open graph tags, etc.), meeting frequency targeting criteria, requests coming from the crawler, checking org tier (paid or unpaid account), and content type (e.g., sensitive content). The decoding app 705 may handle hotspots with respect to deciding to target.

The result of dynamic targeting decisions may be cached in a small in-process LRU. For dynamic targeting based on volume of traffic to a link the increment requests may be used against counters in the existing memcache 750 (e.g., memory cache) used by the decoding app 705. For example, a targeting policy of redirecting ¼th of traffic to the preview interstitial may be executed. Dynamic targeting may be based on the age of a link (e.g., excluding links less than one hour old). Because redirects are performance sensitive to end users (e.g., client 240), constraints may be sent on the structure of implementation. The implementation may be modeled based on the trust and safety templates used by the decoding app 705 and constrain resources to be delivered in a single response. These templates may be designed to be as self-contained and rendered without needing additional resources.

The user experience associated with the preview page may be measured based on a comparison of a page view rate with metrics, and a rate of click throughs (e.g., CTR) to the final URL. These metrics may be recorded as a flag indicating when a preview page was rendered. Records may be recorded in the data stream using a flag indicating when the preview page is rendered. In some cases, since decodes_app sits before bot filtering, the preview page may return to some requests that are later classified into the bots data stream. A new data stream (“preview_page_events”) may be created to record beacon events from the preview page, including a “view” event and a “clickthrough” event tracking navigation to the long URL.

### C. Computing and Network Environment

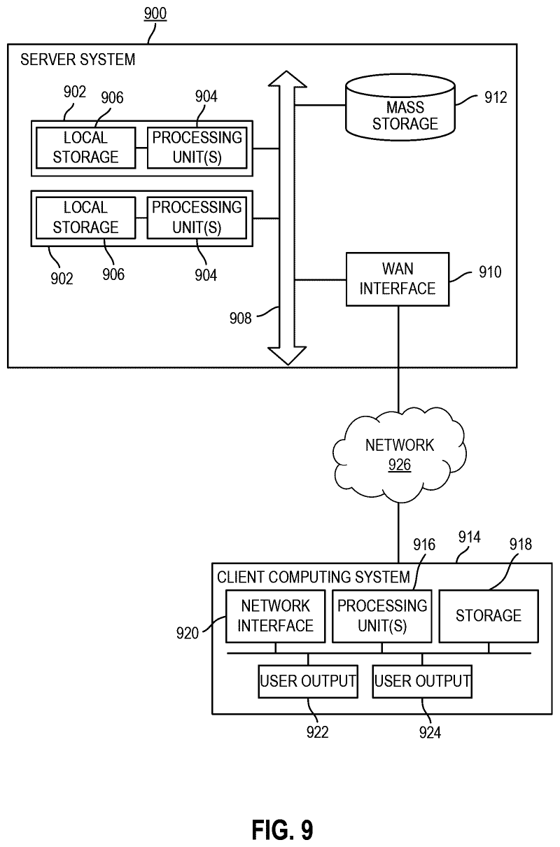

Various operations described herein can be implemented on computer systems. FIG. 9 shows a simplified block diagram of a representative server system 900, client computing system 914, and network 926 usable to implement certain embodiments of the present disclosure. In various embodiments, server system 900 or similar systems can implement services or servers described herein or portions thereof. Client computing system 914 or similar systems can implement clients described herein. The system 900 described herein can be similar to the server system 900. Server system 900 can have a modular design that incorporates a number of modules 902 (e.g., blades in a blade server embodiment); while two modules 902 are shown, any number can be provided. Each module 902 can include processing unit(s) 904 and local storage 906.

Processing unit(s) 904 can include a single processor, which can have one or more cores, or multiple processors. In some embodiments, processing unit(s) 904 can include a general-purpose primary processor as well as one or more special-purpose co-processors such as graphics processors, digital signal processors, or the like. In some embodiments, some or all processing units 904 can be implemented using customized circuits, such as application specific integrated circuits (ASICs) or field programmable gate arrays (FPGAs). In some embodiments, such integrated circuits execute instructions that are stored on the circuit itself. In other embodiments, processing unit(s) 904 can execute instructions stored in local storage 906. Any type of processors in any combination can be included in processing unit(s) 904.

Local storage 906 can include volatile storage media (e.g., DRAM, SRAM, SDRAM, or the like) and/or non-volatile storage media (e.g., magnetic or optical disk, flash memory, or the like). Storage media incorporated in local storage 906 can be fixed, removable or upgradeable as desired. Local storage 906 can be physically or logically divided into various subunits such as a system memory, a read-only memory (ROM), and a permanent storage device. The system memory can be a read-and-write memory device or a volatile read-and-write memory, such as dynamic random-access memory. The system memory can store some or all of the instructions and data that processing unit(s) 904 need at runtime. The ROM can store static data and instructions that are needed by processing unit(s) 904. The permanent storage device can be a non-volatile read-and-write memory device that can store instructions and data even when module 902 is powered down. The term “storage medium” as used herein includes any medium in which data can be stored indefinitely (subject to overwriting, electrical disturbance, power loss, or the like) and does not include carrier waves and transitory electronic signals propagating wirelessly or over wired connections.

In some embodiments, local storage 906 can store one or more software programs to be executed by processing unit(s) 904, such as an operating system and/or programs implementing various server functions such as functions of the system 100 of FIG. 1 and system 200 of FIG. 2 or any other system described herein, or any other server(s) associated with system 100, 200, or any other system described herein.

“Software” refers generally to sequences of instructions that, when executed by processing unit(s) 904 cause server system 900 (or portions thereof) to perform various operations, thus defining one or more specific machine embodiments that execute and perform the operations of the software programs. The instructions can be stored as firmware residing in read-only memory and/or program code stored in non-volatile storage media that can be read into volatile working memory for execution by processing unit(s) 904. Software can be implemented as a single program or a collection of separate programs or program modules that interact as desired. From local storage 906 (or non-local storage described below), processing unit(s) 904 can retrieve program instructions to execute and data to process in order to execute various operations described above.

In some server systems 900, multiple modules 902 can be interconnected via a bus or other interconnect 908, forming a local area network that supports communication between modules 902 and other components of server system 900. Interconnect 908 can be implemented using various technologies including server racks, hubs, routers, etc.

A wide area network (WAN) interface 910 can provide data communication capability between the local area network (interconnect 908) and the network 926, such as the Internet. Technologies can be used, including wired (e.g., Ethernet, IEEE 902.3 standards) and/or wireless technologies (e.g., Wi-Fi, IEEE 902.11 standards).

In some embodiments, local storage 906 is intended to provide working memory for processing unit(s) 904, providing fast access to programs and/or data to be processed while reducing traffic on interconnect 908. Storage for larger quantities of data can be provided on the local area network by one or more mass storage subsystems 912 that can be connected to interconnect 908. Mass storage subsystem 912 can be based on magnetic, optical, semiconductor, or other data storage media. Direct attached storage, storage area networks, network-attached storage, and the like can be used. Any data stores or other collections of data described herein as being produced, consumed, or maintained by a service or server can be stored in mass storage subsystem 912. In some embodiments, additional data storage resources may be accessible via WAN interface 910 (potentially with increased latency).

Server system 900 can operate in response to requests received via WAN interface 910. For example, one of modules 902 can implement a supervisory function and assign discrete tasks to other modules 902 in response to received requests. Work allocation techniques can be used. As requests are processed, results can be returned to the requester via WAN interface 910. Such operation can generally be automated. Further, in some embodiments, WAN interface 910 can connect multiple server systems 900 to each other, providing scalable systems capable of managing high volumes of activity. Other techniques for managing server systems and server farms (collections of server systems that cooperate) can be used, including dynamic resource allocation and reallocation.

Server system 900 can interact with various user-owned or user-operated devices via a wide-area network such as the Internet. An example of a user-operated device is shown in FIG. 9 as client computing system 914. Client computing system 914 can be implemented, for example, as a consumer device such as a smartphone, other mobile phone, tablet computer, wearable computing device (e.g., smart watch, eyeglasses), desktop computer, laptop computer, and so on.

For example, client computing system 914 can communicate via WAN interface 910. Client computing system 914 can include computer components such as processing unit(s) 916, storage device 918, network interface 920, user input device 922, and user output device 924. Client computing system 914 can be a computing device implemented in a variety of form factors, such as a desktop computer, laptop computer, tablet computer, smartphone, other mobile computing device, wearable computing device, or the like.

Processing unit(s) 916 and storage device 918 can be similar to processing unit(s) 904 and local storage 906 described above. Suitable devices can be selected based on the demands to be placed on client computing system 914; for example, client computing system 914 can be implemented as a “thin” client with limited processing capability or as a high-powered computing device. Client computing system 914 can be provisioned with program code executable by processing unit(s) 916 to enable various interactions with server system 900.

Network interface 920 can provide a connection to the network 926, such as a wide area network (e.g., the Internet) to which WAN interface 910 of server system 900 is also connected. In various embodiments, network interface 920 can include a wired interface (e.g., Ethernet) and/or a wireless interface implementing various RF data communication standards such as Wi-Fi, Bluetooth, or cellular data network standards (e.g., 3G, 4G, LTE, etc.).

User input device 922 can include any device (or devices) via which a user can provide signals to client computing system 914; client computing system 914 can interpret the signals as indicative of particular user requests or information. In various embodiments, user input device 922 can include any or all of a keyboard, touch pad, touch screen, mouse or other pointing device, scroll wheel, click wheel, dial, button, switch, keypad, microphone, and so on.

User output device 924 can include any device via which client computing system 914 can provide information to a user. For example, user output device 924 can include a display to display images generated by or delivered to client computing system 914. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). Some embodiments can include a device such as a touchscreen that function as both input and output device. In some embodiments, other user output devices 924 can be provided in addition to or instead of a display. Examples include indicator lights, speakers, tactile “display” devices, printers, and so on.

Some embodiments include electronic components, such as microprocessors, storage and memory that store computer program instructions in a computer-readable storage medium. Many of the features described in this specification can be implemented as processes that are specified as a set of program instructions encoded on a computer-readable storage medium. When these program instructions are executed by one or more processing units, they cause the processing unit(s) to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processing unit(s) 904 and 916 can provide various functionality for server system 900 and client computing system 914, including any of the functionality described herein as being performed by a server or client, or other functionality.

It will be appreciated that server system 900 and client computing system 914 are illustrative and that variations and modifications are possible. Computer systems used in connection with embodiments of the present disclosure can have other capabilities not specifically described here. Further, while server system 900 and client computing system 914 are described with reference to particular blocks, it is to be understood that these blocks are defined for convenience of description and are not intended to imply a particular physical arrangement of component parts. For instance, different blocks can be but need not be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present disclosure can be realized in a variety of apparatus including electronic devices implemented using any combination of circuitry and software.

While the disclosure has been described with respect to specific embodiments, one skilled in the art will recognize that numerous modifications are possible. Embodiments of the disclosure can be realized using a variety of computer systems and communication technologies including but not limited to the specific examples described herein. Embodiments of the present disclosure can be realized using any combination of dedicated components and/or programmable processors and/or other programmable devices. The various processes described herein can be implemented on the same processor or different processors in any combination. Where components are described as being configured to perform certain operations, such configuration can be accomplished, e.g., by designing electronic circuits to perform the operation, by programming programmable electronic circuits (such as microprocessors) to perform the operation, or any combination thereof. Further, while the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features of the present disclosure may be encoded and stored on various computer-readable storage media; suitable media include magnetic disk or tape, optical storage media such as compact disk (CD) or DVD (digital versatile disk), flash memory, and other non-transitory media. Computer-readable media encoded with the program code may be packaged with a compatible electronic device, or the program code may be provided separately from electronic devices (e.g., via Internet download or as a separately packaged computer-readable storage medium).

Thus, although the disclosure has been described with respect to specific embodiments, it will be appreciated that the disclosure is intended to cover all modifications and equivalents within the scope of the following claims.

What is claimed is

1. A method of redirecting client devices via encoded links, comprising:
receiving, by at least one server of a linking system, from a client, a request to access a target webpage via redirection through the linking system, in response to interaction with an encoded link of the linking system on a source webpage;
identifying, by the at least one server, the target webpage to be accessed via the redirection based on the encoded link associated with the request;
determining, by the at least one server, a first metric indicating a degree of risk from providing the target webpage based on content on the target webpage;
determining, by the at least one server, a second metric indicating a frequency of visits to the target webpage via redirection through the linking system;
selecting, by the at least one server, an interstitial element that previews at least a portion of the target webpage, responsive to the first metric being below a first threshold and the second metric exceeding a second threshold; and
transmitting, by the at least one server, to the client, a response to cause the client to display the interstitial element on the source webpage, instead of redirecting the client to the target webpage.

2. The method of claim 1, further comprising:
receiving, by the at least one server of the linking system, from the client, a second request to access a second target webpage via redirection through the linking system, in response to interaction with a second encoded link of the linking system on a second source webpage;
determining, by the at least one server, a third metric indicating a frequency of visits by the second target webpage;
selecting, by the at least one server, the second target webpage instead of a second interstitial element that previews at least a portion of the second target webpage, responsive to the third metric being below the second threshold; and
transmitting, by the at least one server, to the client, a second response to redirect the client from the second source webpage to the second target webpage, instead of presentation of the second interstitial element on the second source webpage.

3. The method of claim 1, further comprising:
determining, by the at least one server, a third metric indicating a degree of risk from presentation of a second target webpage based on content on a second target webpage; and
generating, by the at least one server, a second interstitial element to include at least one of a target webpage URL, a page title, a page description, or a keyword associated with a second target webpage, responsive to the third metric exceeding the first threshold.

4. The method of claim 1, further comprising generating, by the at least one server, responsive to the first metric being below the first threshold, the interstitial element to include at least the portion of the target webpage and a user interface element, the user interface element configured to permit redirection of the client to the target webpage responsive to an interaction subsequent to elapsing of a time delay relative to provision of the interstitial element.

5. The method of claim 1, further comprising determining, by the at least one server, that the request is valid based on a type of content identified in a header of the request;
wherein selecting the target webpage further comprises selecting the target webpage instead of the interstitial element, responsive to determining that the request is valid.

6. The method of claim 1, further comprising identifying, by the at least one server, a type of account for a content provider associated with the encoded link as corresponding to a defined type;
wherein selecting the target webpage further comprises selecting the target webpage instead of the interstitial element, responsive to identifying the type of account as corresponding to the defined type.

7. The method of claim 1, further comprising:
identifying, by the at least one server, an activity log of the client in accessing target webpages via the redirection through the linking system using a cookie of the linking system on the client, responsive to the first metric exceeding the first threshold; and
determining, by the at least one server, a third metric indicating a number of visits by the client to the target webpage based on the activity log;
wherein selecting the target webpage further comprises selecting the target webpage instead of the interstitial element, responsive to the third metric exceeding a third threshold.

8. The method of claim 1, further comprising:
identifying, by the at least one server, an activity log of the client in accessing target webpages via the redirection through the linking system using a cookie of the linking system on the client, responsive to the first metric exceeding the first threshold; and
determining, by the at least one server, based on the activity log, that the client was presented with a second interstitial element in response to a second request to access a second target webpage via the redirection through the linking system;
wherein selecting the target webpage further comprises selecting the target webpage instead of the interstitial element, responsive to determining that the client was presented with the second interstitial element.

9. The method of claim 1, further comprising:
generating, by the at least one server, using a resource identifier referencing to a host server and the first target webpage, the encoded link configured to redirect the client through the linking system to the first target webpage referenced by the resource identifier; and
selecting, by the at least one server, a subset of tiers from a plurality of tiers against which to check the request, the subset of tiers including (i) comparing the first metric indicating the risk against the first threshold and (ii) comparing the second metric indicating frequency of visits against the second threshold.

10. The method of claim 1, further comprising storing, by the at least one server, on a database, (i) a determination to select the preview interstitial element and (ii) a plurality of factors including the first metric and the second metric.

11. A system for redirecting client devices via encoded links, comprising:
at least one server of a linking system having one or more processors coupled with memory, configured to:
receive, from a client, a request to access a target webpage via redirection through the linking system, in response to interaction with an encoded link of the linking system on a source webpage;
identify the target webpage to be accessed via the redirection based on the encoded link associated with the request;
determine a first metric indicating a degree of risk from providing the target webpage based on content on the target webpage;
determine a second metric indicating a frequency of visits to the target webpage via redirection through the linking system;
select an interstitial element that previews at least a portion of the target webpage, responsive to the first metric being below a first threshold and the second metric exceeding a second threshold; and
transmit, to the client, a response to cause the client to present interstitial element on the source webpage, instead of redirecting the client to the target webpage.

12. The system of claim 11, wherein the at least one server is further configured to:
receive, from the client, a second request to access a second target webpage via redirection through the linking system, in response to interaction with a second encoded link of the linking system on a second source webpage;
determine a third metric indicating a frequency of visits by the second target webpage;
select the second target webpage instead of a second interstitial element corresponding to at least a portion of the second target webpage, responsive to the third metric exceeding the second threshold; and
transmit, to the client, a second response to redirect the client from the second source webpage to the second target webpage, instead of presentation of the second interstitial element on the second source webpage.

13. The system of claim 11, wherein the at least one server is further configured to:
determine a third metric indicating a degree of risk from presentation of a second target webpage based on content on a second target webpage; and
generate a second interstitial element to include at least one of a target webpage URL, a page title, a page description, or a keyword associated with a second target webpage, responsive to the third metric being below the first threshold.

14. The system of claim 11, wherein the at least one server is further configured to generate, responsive to the first metric being below the first threshold, the interstitial element to include at least the portion of the target webpage and a user interface element, the user interface element configured to permit redirection of the client to the target webpage responsive to an interaction subsequent to elapsing of a time delay relative to provision of the interstitial element.

15. The system of claim 11, wherein the at least one server is further configured to:
determine that the request is valid based on a type of content identified in a header of the request;
select the target webpage instead of the interstitial element, responsive to determining that the request is valid.

16. The system of claim 11, wherein the at least one server is further configured to:
identify a type of account for a content provider associated with the encoded link as corresponding to a defined type;
select the target webpage instead of the interstitial element, responsive to identifying the type of account as corresponding to the defined type.

17. The system of claim 11, wherein the at least one server is further configured to:
identify an activity log of the client in accessing target webpages via the redirection through the linking system using a cookie of the linking system on the client, responsive to the first metric exceeding the first threshold; and
determine a third metric indicating a number of visits by the client to the target webpage based on the activity log;
select the target webpage instead of the interstitial element, responsive to the third metric exceeding a third threshold.

18. The system of claim 11, wherein the at least one server is further configured to:
identify an activity log of the client in accessing target webpages via the redirection through the linking system using a cookie of the linking system on the client, responsive to the first metric exceeding the first threshold; and
determine based on the activity log, that the client was presented with a second interstitial element in response to a second request to access a second target webpage via the redirection through the linking system;
select the target webpage instead of the interstitial element, responsive to determining that the client was presented with the second interstitial element.

19. The system of claim 11, wherein the at least one server is further configured to:
generate, using a resource identifier referencing to a host server and the first target webpage, the encoded link configured to redirect the client through the linking system to the first target webpage referenced by the resource identifier; and
select a subset of tiers from a plurality of tiers against which to check the request, the subset of tiers including (i) comparing the first metric indicating the risk against the first threshold and (ii) comparing the second metric indicating frequency of visits against the second threshold.

20. The system of claim 11, wherein the at least one server is further configured to store, on a database, (i) a determination to select the preview interstitial element and (ii) a plurality of factors including the first metric and the second metric, to use in a subsequent determination of providing the preview interstitial element.
